(19) United States
(12) Patent Application Publication
(10) Pub. No.: US 2022/0123415 A1
(43) Pub. Date: Apr. 21, 2022

(54) Method for Manufacturing Battery Module

(71) Applicants: HYUNDAI MOTOR COMPANY, Seoul (KR); Kia Corporation, Seoul (KR)

(72) Inventors: Gyung Hoon SHIN, Seoul (KR); Yong Hwan CHOI, Seoul (KR); Wu Hyun KIM, Goyang-si (KR); Yu Ri OH, Hwaseong-si (KR); Hae Kyu LIM, Bucheon-si (KR); Ji Woong JUNG, Anyang-si (KR)

(73) Assignees: HYUNDAI MOTOR COMPANY, Seoul (KR); Kia Corporation, Seoul (KR)

(21) Appl. No.: 17/395,190

(22) Filed: Aug. 5, 2021

(30) Foreign Application Priority Data
Oct. 20, 2020 (KR) 10-2020-0136237

(51) Int. Cl. H01M 50/262; H01M 50/209; H01M 50/564

(52) U.S. Cl. CPC H01M 50/262; H01M 50/564; H01M 50/209

(57) ABSTRACT

A method for manufacturing a battery module includes: forming a stacked structure by stacking a plurality of battery cell assemblies in a first direction; bringing a first end plate in surface contact with a first end of the stacked structure and bringing a second end plate in surface contact with a second of the stacked structure in the first direction; forming electrical connection by bonding electrodes of each battery cells of the plurality of battery cells to each other; and installing a first clamp and a second clamp across the stacked structure in the first direction, fixing first ends of the first clamp and the second clamp to the first end plate, and fixing second ends of the first clamp and the second clamp to the second end plate.

### CROSS REFERENCE TO RELATED APPLICATION

This application claims priority to and the benefit of Korean Patent Application No. 10-2020-0136237, filed on Oct. 20, 2020, the entire contents of which are incorporated herein by reference.

### FIELD

The present disclosure relates to a method for manufacturing a battery module.

### BACKGROUND

The statements in this section merely provide background information related to the present disclosure and may not constitute prior art.

In line with recent global trends toward carbon dioxide emission reduction, there has been an increasing demand for electric cars that produce traveling power by driving motors with electric energy stored in energy storage devices (for example, batteries), instead of conventional cars having internal combustion engines to produce traveling power by means of combustion of fossil fuel.

The performance of an electric car heavily depends on the capacity and performance of the energy storage device (for example, battery) for storing electric energy to be supplied to the driving motor.

Vehicle batteries for storing electric energy to be supplied to motors to produce traveling power for the vehicles desirably have not only excellent electric characteristics (for example, excellent charging/discharging performance and long service life), but also high-level mechanical performances (for example, robustness against harsh vehicle traveling environments, such as high temperatures and severe vibrations).

Accordingly, we have discovered that a battery structure capable of providing excellent electrical/mechanical performances and a method for manufacturing the same are desired.

The above descriptions regarding background arts are only for helping understanding of the background of the present disclosure, and are not to be considered by a person skilled in the art as corresponding to already-known prior arts.

### SUMMARY

Further areas of applicability will become apparent from the description provided herein. It should be understood that the description and specific examples are intended for purposes of illustration only and are not intended to limit the scope of the present disclosure.

The present disclosure to provides a battery module and a method for manufacturing the same, wherein a structure for restriction among components, which can provide a sufficient level of rigidity, is applied such that a sufficient level of coupling among the components can be provided.

In one form of the present disclosure, a method for manufacturing a battery module includes the steps of: forming a stacked structure by stacking a plurality of battery cells in a first direction; bringing a first end plate and a second end plate in surface contact with both ends of the stacked structure, respectively, in the first direction; forming electrical connection by bonding electrodes of the battery cells to each other; and installing clamps across the stacked structure in the first direction such that both ends thereof are fixed to the first end plate and the second end plate, respectively.

In one form of the present disclosure, the step of forming a stacked structure may include the steps of: forming a battery cell assembly by stacking a plurality of battery cells with a surface pressure pad disposed between the battery cells; and forming the stacked structure by stacking the battery cell assemblies.

In one form of the present disclosure, the battery cells of the battery cell assembly may be stacked such that electrodes having the same polarity of the battery cells are disposed adjacent to each other.

In one form of the present disclosure, the battery cell assemblies of the stacked structure may be stacked such that electrodes having different polarities of the battery cell assemblies are adjacent to each other.

In one form of the present disclosure, the step of forming electrical connection may dispose bus bar assemblies having bus bars having slits at both ends of the stacked structure in a second direction perpendicular to the first direction, may pass electrodes of the battery cells through the slits, may bend the electrodes passing through the slits, and may then weld the bent portions to the bus bars.

In one form of the present disclosure, the step of installing clamps may include the steps of: disposing a cover at an end of the stacked structure in a direction perpendicular to the first direction and a second direction; installing a first clamp as a clamp crossing the stacked structure in the first direction at the outside of the cover such that both ends thereof are fixed to the first end plate and the second end plate; and installing a second clamp as a clamp crossing the stacked structure at the other end opposite the end, where the cover is disposed, of the stacked structure such that both ends thereof are fixed to the first end plate and the second end plate.

In one form of the present disclosure, both ends of each of the first clamp and the second clamp may be bent toward outer surfaces of the first end plate and the second end plate, and the bent ends may be welded to the first end plate and the second end plate.

In one form of the present disclosure, the method may further include a step of installing a first cover and a second cover respectively at both ends of the stacked structure in a second direction perpendicular to the first direction.

In one form of the present disclosure, both side surfaces of the first cover and both side surfaces of the second cover may be in surface contact with the first end plate and the second end plate, respectively.

In one form of the present disclosure, both side surfaces of the first cover and both side surfaces of the second cover may be bolted to the first end plate and the second end plate.

In one form of the present disclosure, locking protrusions protruding in the first direction may be formed on both side surfaces of the first cover and both side surfaces of the second cover, and edges of the first end plate and the second end plates may be locked to the locking protrusions to be restricted in an assembled state.

According to the battery module manufacturing method, clamps are welded to end plates at both sides at the center of the battery module in the direction in which battery cells are stacked, and the end plates are bolted to covers at both ends, whereby it is possible to provide sufficient rigidity.

In addition, according to the battery module manufacturing method, since it is possible to form electrical connection between electrodes of a plurality of stacked battery cells through one bending process and one welding process by employing bus bar assemblies, it is possible to improve the quality of the product by simplifying processes and removing resultant differences between battery cells.

In addition, according to the battery module manufacturing method, a structure for restriction among components is used such that a sufficient level of coupling among the components can be provided during manufacturing processes, thereby providing high levels of manufacturing quality and uniformity between resultant products.

Advantageous effects obtainable from the present disclosure are not limited to those mentioned above, and other advantageous effects not mentioned herein could be clearly understood by those skilled in the art to which the present disclosure pertains.

### DRAWINGS

In order that the disclosure may be well understood, there will now be described various forms thereof, given by way of example, reference being made to the accompanying drawings, in which:

FIG. 1 is a perspective view of a battery module manufactured by a method for manufacturing a battery module according to one form of the present disclosure;

FIG. 2 is an exploded perspective view of the battery module shown in FIG. 1;

FIGS. 3 and 4 are views showing a step of forming a battery cell-stacked structure in the method for manufacturing a battery module according to one form of the present disclosure;

FIG. 5 is a view showing a step of bringing end plates in surface contact with the battery cell-stacked structure in the method for manufacturing a battery module according to one form of the present disclosure;

FIG. 6 is a view enlarging the outer surface and the inner surface of the end plate shown in FIG. 5;

FIG. 7 is a view showing a step of bonding battery cell electrodes by installing bus bar assemblies on the battery cell-stacked structure in the method for manufacturing a battery module according to one form of the present disclosure;

FIG. 8 is a view enlarging the bus bar assembly shown in FIG. 7;

FIG. 9 is a view showing the result of installing bus bar assemblies on the battery cell-stacked structure and welding battery cell electrodes in the method for manufacturing a battery module according to one form of the present disclosure;

FIG. 10 is a view showing a step of disposing covers and clamps in the method for manufacturing a battery module according to one form of the present disclosure;

FIG. 11 is a view showing an end of the first clamp shown in FIG. 10;

FIG. 12 is a view showing a step of installing a second cover and a third cover in the method for manufacturing a battery module according to one form of the present disclosure; and

FIG. 13 is a view showing in detail an assembly structure of the second cover and the third cover in the method for manufacturing a battery module according to one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereafter, a method for manufacturing a battery module according to various forms of the present disclosure is described with reference to the accompanying drawings.

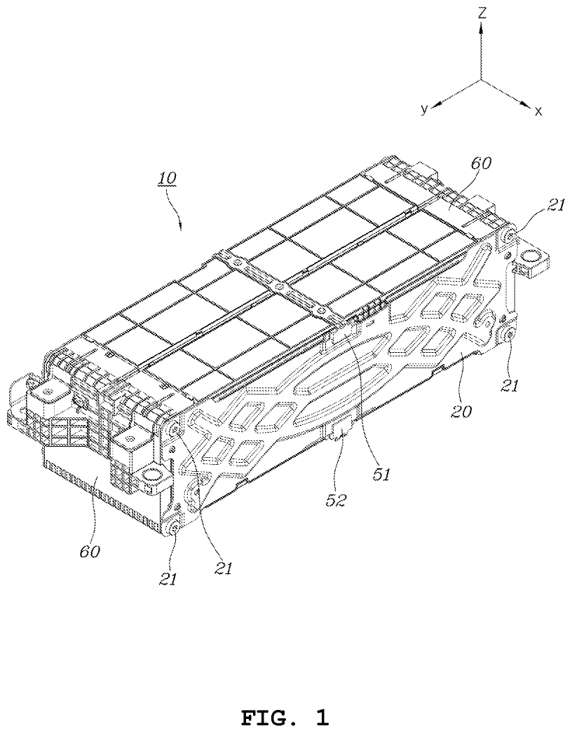

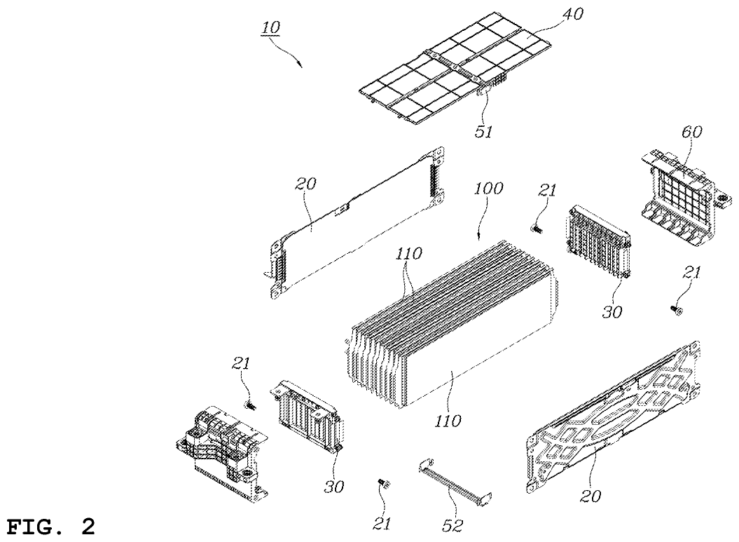

FIG. 1 is a perspective view of a battery module manufactured by a method for manufacturing a battery module according to one form of the present disclosure and FIG. 2 is an exploded perspective view of the battery module shown in FIG. 1.

As shown in FIGS. 1 and 2, a battery module 10 manufactured by a method for manufacturing a battery module according to one form of the present disclosure may include: a plurality of battery cells 110 stacked on each other in a first direction; two end plates 20 respectively being in surface contact with both ends in the first direction of a structure 100 of the stacked battery cells 110; bus bar assemblies 30 bonding electrodes of the battery cells 110 to each other at both ends of the structure 100 of the stacked battery cells 110 in a second direction perpendicular to the first direction; a first cover 40 covering an end of the structure 100 of the stacked battery cells 110 in a third direction perpendicular to the first direction and the second direction; a first clamp 51 having both ends connected between the two end plates 20 across the cover 40 at the outside of the cover 40; a second clamp 52 having both ends respectively connected to the two end plates 20 across the structure 100 at an end, which faces the position where the cover 40 is disposed, of the structure 100 of the stacked battery cells 110; and a second cover and a third cover 60 covering the structure 100 of the stacked battery cells 110 in the second direction at the outside of the bus bar assemblies 30. Side surfaces of the second cover and the third cover 60 are in contact with ends of the end plates 20, and the second cover, the third cover 60, and the end plates 20 can be combined by bolts 21.

A method for manufacturing the battery module 10 shown in FIGS. 1 and 2 may start first with a step of forming the battery cell-stacked structure 100 by stacking the battery cells 110.

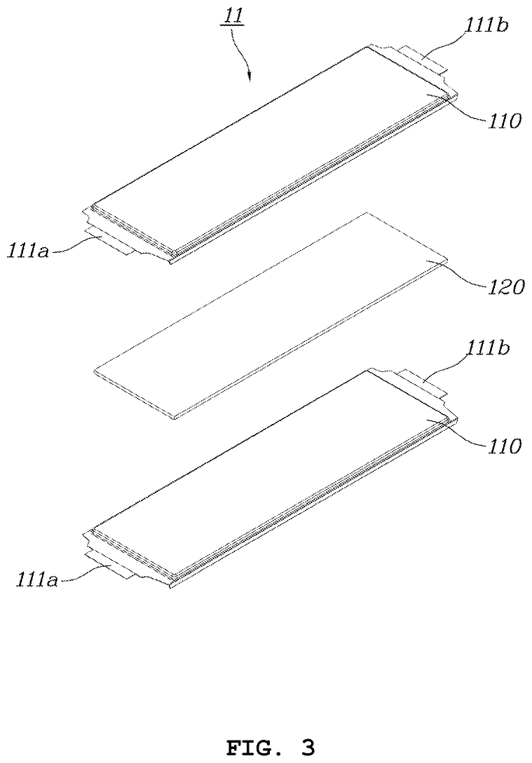

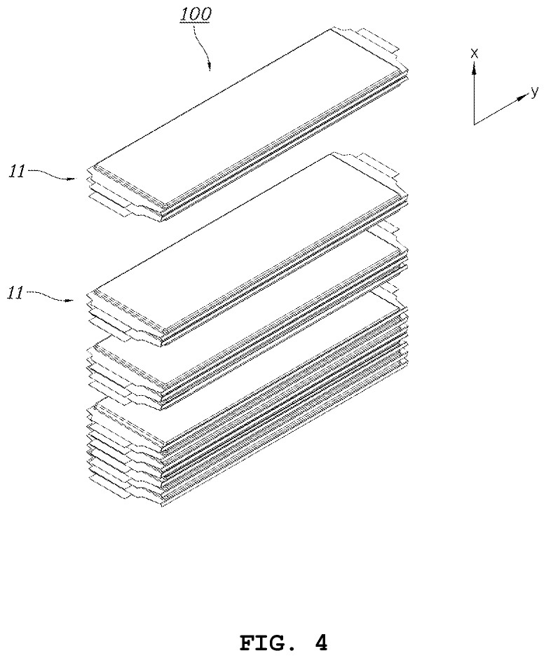

FIGS. 3 and 4 are views showing a step of forming a battery cell-stacked structure in the method for manufacturing a battery module according to one form of the present disclosure.

Referring to FIGS. 3 and 4, the step of forming a battery cell-stacked structure forms first a battery assembly 11 by alternately stacking a plurality (e.g., two) battery cells 110 and a surface pressure pad 120 supposed to be disposed between the battery cells 110 and then stacks a plurality of battery cell assemblies 11, thereby being able to form the battery cell-stacked structure 100.

The battery cells 110 may be disposed in one battery cell assembly 11 such that electrodes having the same polarity (e.g., positive electrodes 111a and negative electrodes 111b) are adjacent to each other.

The surface pressure pad 120 is a component for preventing deformation of the structure of a module by providing elasticity when the battery cell 110 swells.

A hot melt may be applied between the battery cell assemblies 11, whereby the position between the battery cell assemblies 11 may be restricted.

The battery cell assemblies 11 may be stacked such that electrodes having different polarities are adjacent to each other. When the battery cells 110 are bonded to the bus bar assemblies 30, the adjacent electrodes having opposite polarities are bonded to the bus bars of the bus bar assemblies 30, so the battery cell assemblies 11 can form an electrical series connection relationship and the battery cells 110 in one battery cell assembly 11 can form an electrical parallel connection relationship.

Hereafter, for the convenience of description, the direction in which the battery cells 110 are stacked is referred to as the first direction (x-axial direction) and the direction perpendicular to the first direction in which the electrodes of the battery cells 110 are connected is referred to as a second direction (y-axial direction). Further, the direction that is perpendicular to the first direction and the second direction, that is, the direction in which sides without an electrode of the battery cells 110 are connected is referred to as the third direction (z-axial direction).

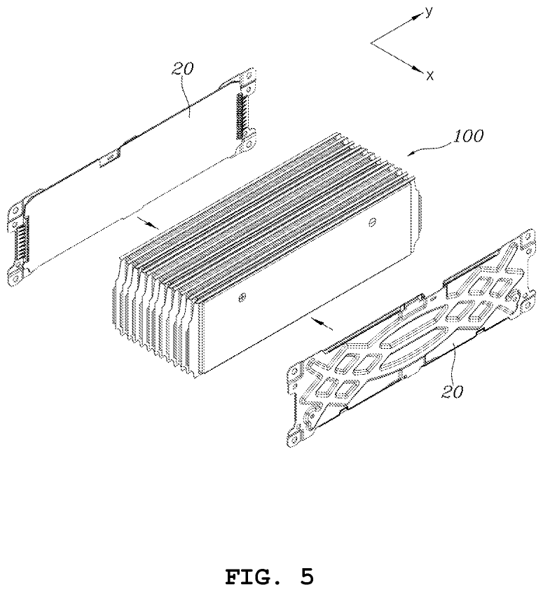

Next, the method for manufacturing a battery module according to one form of the present disclosure may perform a step of disposing the end plates 20 in surface contact with both ends of the stacked structure 100 in the first direction that is the stacking direction of the battery cell-stacked structure 100, as shown in FIG. 5.

FIG. 5 is a view showing a step of bringing end plates in surface contact with the battery cell-stacked structure in the method for manufacturing a battery module according to one form of the present disclosure.

The end plates are plates that are disposed in surface contact with the outermost battery cells in parallel with the battery cells in the direction in which the battery cells are stacked.

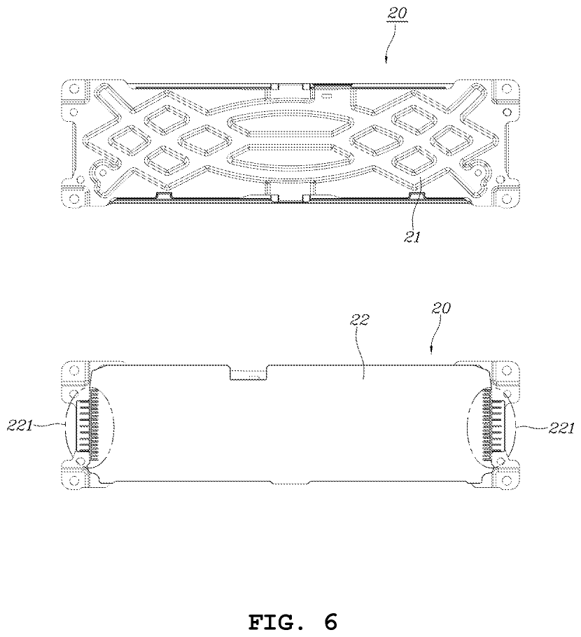

FIG. 6 is a view enlarging the outer surface and the inner surface of the end plate shown in FIG. 5.

As shown in FIG. 6, a surface 21, which is exposed out of the module 10, of the end plate 20 may be made of metal such as aluminum and an inner surface 22 supposed to come in surface contact with an outermost battery cell 110 of the stacked structure 100 may be made of an insulating material such as plastic.

A bead structure 221 for restricting a position when being in contact with the battery cells 110 may be formed on the inner surface 22 of the end plate 20. The bead structure 221 comes in contact with a convex portion at the centers of the battery cells and guides the positions, thereby being able to restrict the positions before the positions of the battery cells are physically fixed.

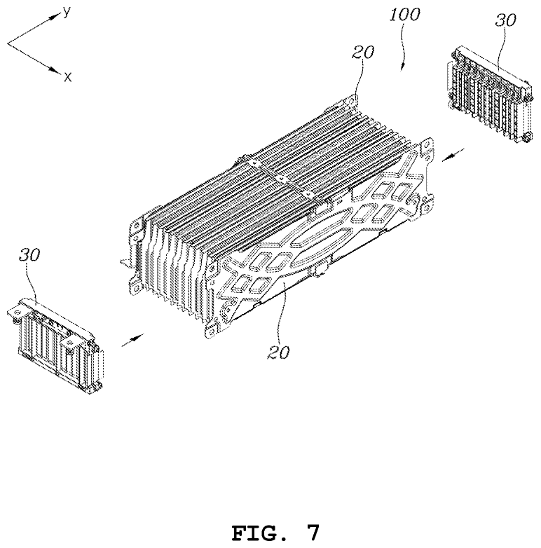

Next, the method for manufacturing a battery module according to one form of the present disclosure, as shown in FIG. 7, may perform a step of bonding the electrodes of the battery cells 110 in the stacked structure 100 by installing the bus bar assemblies 30 at both ends of the stacked structure 100 in the second direction perpendicular to the stacking direction of the battery cell-stacked structure 100, that is, in the direction in which the electrodes 111a and 111b of the battery cells 110 are connected.

FIG. 7 is a view showing a step of bonding battery cell electrodes by installing bus bar assemblies on the battery cell-stacked structure in the method for manufacturing a battery module according to one form of the present disclosure.

As shown in FIG. 7, in the stacked structure 100 combined with the end plates 20, the electrodes 111a and 111b of the battery cells 110 are bent through the bus bar assemblies 30 and then welded without the electrodes 111a and 111b of the battery cells 110 electrically connected, whereby the battery cells 110 in the module 10 can be electrically connected.

In one form of the present disclosure, it is possible to efficiently connect the electrodes of all the battery cells 110 in the battery module 10 using the bus bar assemblies 30.

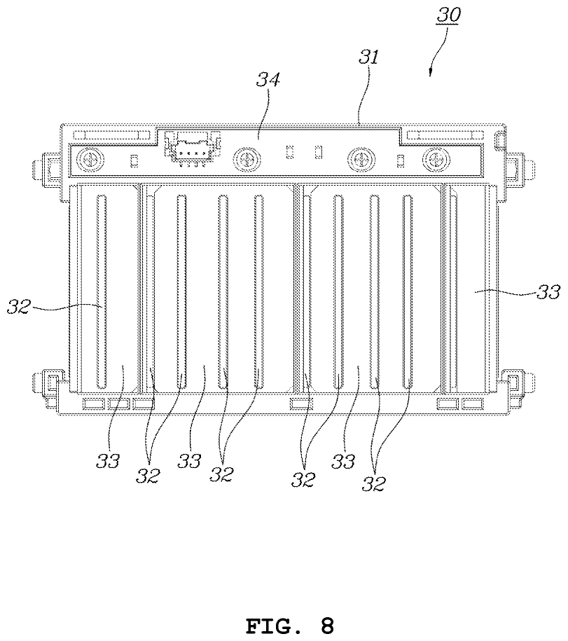

FIG. 8 is a view enlarging the bus bar assembly shown in FIG. 7.

As shown in FIG. 8, the bus bar assembly 30 may include a frame 31 made of an insulating material such as plastic, and bus bars 32 attached to the frame 31 and having slits 33 in which the electrodes 111a and 111b of the battery cells 110 can be inserted. The gaps between the slits 33 may be gaps corresponding to the gaps between the electrodes 111a and 111b of the battery cells 110 disposed in the stacked structure 100. The frame 31 may have partition walls 35 formed in the regions between bus bars to be electrically insulated from each other.

The bus bar assembly 30 may include a Cell Management Unit (CMU) 34 that can monitor the voltage of the battery cells 110 in a battery module.

When the electrodes 111a and 111b of the battery cells 110 are inserted in the slits 33 formed at the bus bars 32 of the bus bar assembly 30, it is possible to bond the bus bars 32 and the electrodes 111a and 111b of the battery cells 110 to each other by bending all the electrodes 111a and 111b of the battery cells 110 one time to come in contact with the bus bars 32 and then welding them one time.

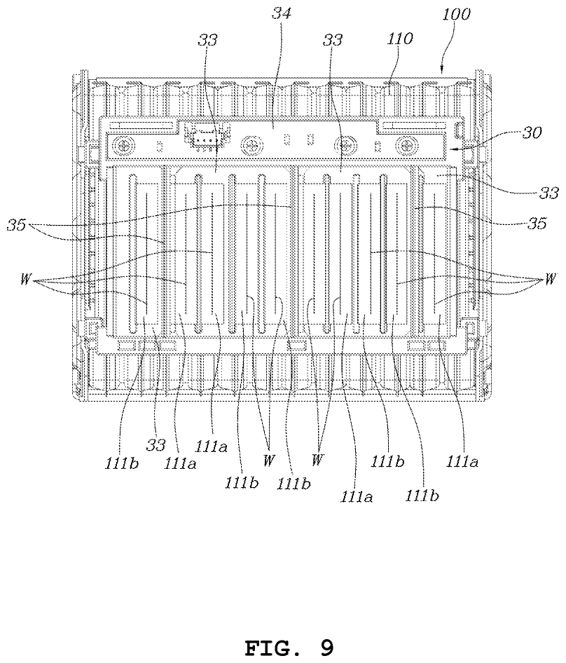

FIG. 9 is a view showing the result of installing bus bar assemblies on the battery cell-stacked structure and welding battery cell electrodes in the method for manufacturing a battery module according to one form of the present disclosure.

According to battery modules in the related art, a method of implementing electrical connection of a battery cell-stacked structure by bending the electrodes of unit battery cells in advance, performing primary welding, stacking a plurality of battery cells again, and then performing secondary welding is applied. Such a method in the related art has a problem that not only bending and welding are performed several times, but also steps are formed on the welded objects in the secondary welding because it is difficult to provide uniformity.

However, as shown in FIG. 9, according to one form of the present disclosure, it is possible to electrically connect all battery cells in a battery module through one bending process and one welding process by applying the bus bar assembly 30, whereby it is possible to simplify the processes and improve the quality of the product.

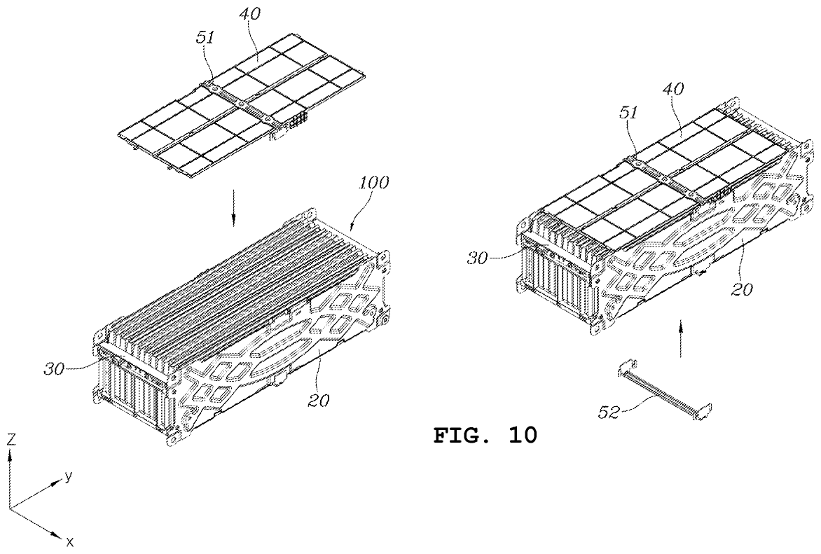

The method for manufacturing a battery module according to one form of the present disclosure, as shown in FIG. 10, may perform a step of disposing the first cover 40 on an end of the stacked structure 100 in the third direction of the battery cell-stacked structure 100, that is, in the direction in which the sides without the electrodes 111a and 111b of the battery cells 110 are connected, and of disposing the first clamp 51 and the second clamp 52 each having both ends bonded to both end plates 20 across the battery cell-stacked structure at the outside of the first cover 40 and at the other end facing the end on which the first cover 40 is disposed.

FIG. 10 is a view showing a step of disposing covers and clamps in the method for manufacturing a battery module according to one form of the present disclosure.

As shown in FIG. 10, the first clamp 51 is fixed to the first cover 40, thereby being able to maintain the distance between the two end plates 20 even though the battery cells 110 swell. Further, the second clamp 52 is disposed on the exposed surface (the bottom in the figures) of the stacked structure 100, thereby, similar to the first clamp 51, being able to maintain the distance between the two end plates 20 even though the battery cells swell.

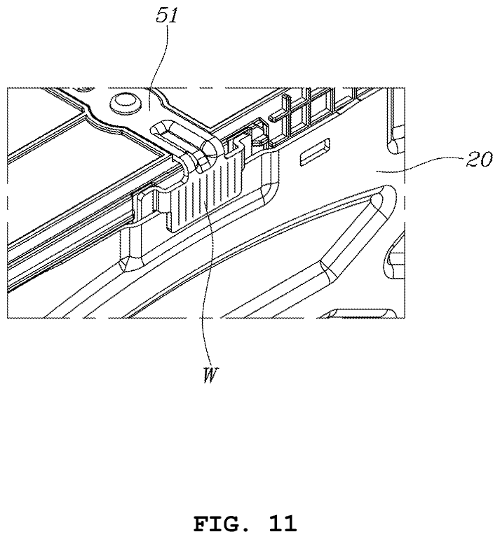

FIG. 11 is a view showing an end of the first clamp shown in FIG. 10.

As shown in FIG. 11, an end of the first clamp 51 may have a hook-like structure bent toward the end plate 20 and the bent end may be fixed to the end plates 20 by being welded to the edges (‘W’: welded regions) of the end plates 20. The bonding structure shown in FIG. 11 can be applied to the second clamp 52 in the same way.

That is, the first clamp 51 and the second clamp 52 each have a structure extending in the stacking direction of the battery cells and the other end bent and bonded to the outer surface of the end plate 20, thereby being able to forcibly maintain the length in the cell-stacking direction even though the battery cells swell.

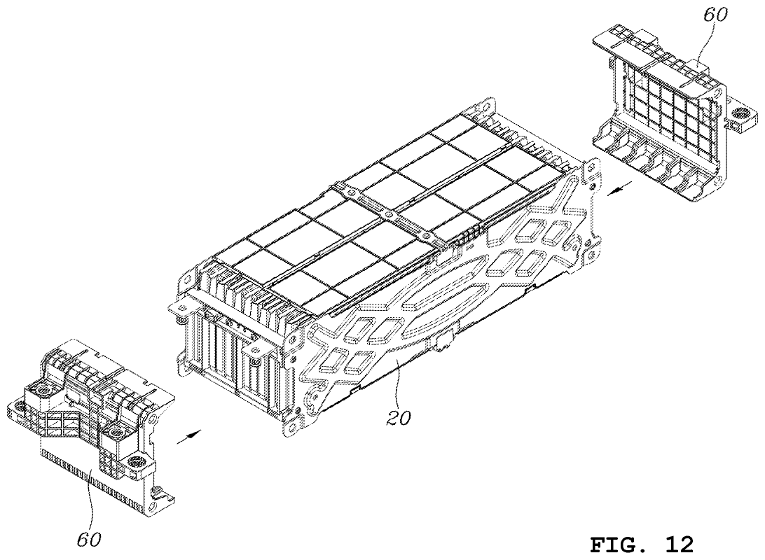

Further, the method for manufacturing a battery module according to one form of the present disclosure, as shown in FIG. 12, may perform a step of installing the second and third covers 60 respectively at both ends of the stacked structure 100 in the second direction perpendicular to the stacking direction of the battery cell-stacked structure 100, that is, in the direction in which the electrodes 111a and 111b of the battery cells 110 are connected.

FIG. 12 is a view showing a step of installing a second cover and a third cover in the method for manufacturing a battery module according to one form of the present disclosure.

As shown in FIG. 12, the second and third covers are substantially the same components disposed at symmetric positions on the battery module 10, so they are given the same reference numeral. By installing the second and third covers 60, the bus bar assemblies 30 are covered and the battery module 10 can be finally completed.

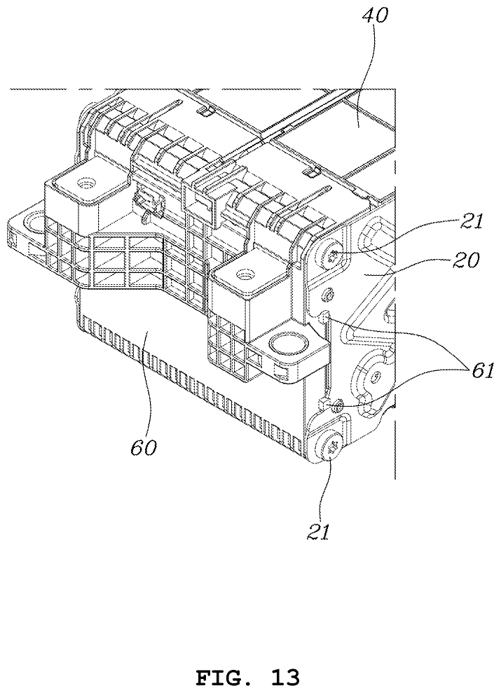

FIG. 13 is a view showing in detail an assembly structure of the second cover and the third cover in the method for manufacturing a battery module according to one form of the present disclosure.

As shown in FIG. 13, side surfaces of the second and third covers 60 may be in contact with the end plates 20. The end plates 20 and the side surfaces of the second and the third cover 60 may be coupled to each other by bolts 21. Further, locking protrusions 61 protruding in the first direction may be formed on the side surfaces of the second cover and the third cover 60 and the edges of the end plates are locked to the locking protrusions 61, whereby the covers and the end plates can be locked to each other in an assembly state.

As described above, according to the method for manufacturing a battery module according to various forms of the present disclosure, clamps are welded to end plates at both sides at the center of battery module in the direction in which battery cells are stacked, and the end plates are bolted to covers at both ends, whereby it is possible to provide sufficient rigidity. Further, according to the method for manufacturing a battery module according to various forms of the present disclosure, since it is possible to implement electrical connection between electrodes of a plurality of stacked battery cells through one bending process and one welding process by employing bus bar assemblies, it is possible to improve the quality of the product by simplifying processes and removing resultant differences between battery cells. Further, the method for manufacturing a battery module according to various forms of the present disclosure can sufficiently provide the coupling force between components in the manufacturing process using the structure for restricting the components, so it is possible to secure the manufacturing quality and uniformity between the resultant products at a high level.

Although the present disclosure was described above with reference to exemplary forms, it would be apparent to those skilled in the art that the present disclosure may be changed and modified in various ways.

What is claimed is:

1. A method for manufacturing a battery module, the method comprising:
forming a stacked structure by stacking a plurality of battery cell assemblies in a first direction;
bringing a first end plate in surface contact with a first end of the stacked structure and bringing a second end plate in surface contact with a second end of the stacked structure in the first direction;
forming electrical connection by bonding electrodes of battery cell assemblies of the plurality of battery cell assemblies to each other; and
installing a first clamp and a second clamp across the stacked structure in the first direction, fixing first ends of the first clamp and the second clamp to the first end plate, and fixing second ends of the first clamp and the second clamp to the second end plate.

2. The method of claim 1, wherein forming the stacked structure includes:
forming each battery cell assembly of the plurality of battery cell assemblies by stacking at least two battery cells with a surface pressure pad disposed therebetween.

3. The method of claim 2, wherein the at least two battery cells of the battery cell assembly are stacked such that electrodes having same polarity of the at least two battery cells are disposed adjacent to each other.

4. The method of claim 3, wherein the battery cell assemblies of the stacked structure are stacked such that electrodes having different polarities of the battery cell assemblies are disposed adjacent to each other.

5. The method of claim 1, wherein forming the electrical connection includes:
disposing bus bar assemblies, which includes bus bars including slits, at both the first and the second ends of the stacked structure in a second direction perpendicular to the first direction; and
passing electrodes of the plurality of battery cell assemblies through the slits, bending the electrodes passing through the slits, and then welding bent portions to the bus bars.

6. The method of claim 1, wherein installing the first clamp and the second clamp includes:
disposing a cover at a first end of the stacked structure in a direction perpendicular to the first direction and a second direction;
installing the first clamp and the second clamp crossing the stacked structure in the first direction at an outside of the cover; and
fixing first ends of the first and the second clamps to the first end plate and fixing second ends of the first and the second clamps to the second end plate.

7. The method of claim 6, wherein the first ends of the first and second clamps are bent toward an outer surface of the first end plate and are welded to the first end plate, and the second ends of the first and the second clamps are bent toward an outer surface of the second end plate and are welded to the second end plate.

8. The method of claim 1, further comprising installing a first cover at a first end of the stacked structure and a second cover at a second end of the stacked structure in a second direction perpendicular to the first direction.

9. The method of claim 8, wherein installing the first cover and the second cover comprises:
surface contacting a first and a second side surfaces of the first cover with the first end plate and surface contacting a first and a second side surfaces of the second cover with the second end plate.

10. The method of claim 9, wherein installing the first cover and the second cover further comprises:
bolting the first and the second side surfaces of the first cover to the first endplate and bolting the first and the second side surfaces of the second cover to the second end plate.

11. The method of claim 9, wherein installing the first cover and the second cover comprises:
forming locking protrusions protruding in the first direction on both the first and the second side surfaces of the first cover and both the first and the second side surfaces of the second cover; and
locking an edge of the first end plate to the locking protrusions of the first cover and locking an edge of the second end plate to the locking protrusions of the second cover.
